(19) United States
(12) Patent Application Publication
(10) Pub. No.: US 2004/0054578 A1
(43) Pub. Date: Mar. 18, 2004

(54) Method and system for an incentive-based program

(76) Inventor: Edward Jack Edgington JR., Corinth, TX (US)

Correspondence Address: Gary L. Bush, Esq., Andrews & Kurth L.L.P., 600 Travis, Suite 4200, Houston, TX, 77002-2778, US

(21) Appl. No.: 10/389,040

(22) Filed: Mar. 14, 2003

Related U.S. Application Data
(60) Provisional application No. 60/364,267, filed on Mar. 14, 2002.

(51) Int. Cl. G06F 17/60

(52) U.S. Cl. 705/14

(57) ABSTRACT

An automated method and system for an incentive-based program. The method facilitates the operation of promotional programs. Clients supply customer databases which are downloaded into the system. CD-ROM brochures are generated and mailed to these customers who request free gifts and/or order products directly from the web site. Customer information generated from these orders is tracked and utilized to create shipping information. Upon completion of the promotion, an overall summary report is generated and delivered.

### CROSS-REFERENCE TO RELATED APPLICATIONS

The present application claims the benefit of U.S. Provisional Application No. 60/364,267, filed Mar. 14, 2002.

### BACKGROUND OF THE INVENTION

The present invention includes embodiments generally related to incentive-based programs, and more specifically to a method and implementation in which an automated database is used to track customer responses to product demonstrations, as well as all promotional efforts generated on behalf of a client.

In today's competitive marketplace, there is often a need to use promotional programs to create incentive for customers to purchase specific products and/or services. In order to make promotional programs most effective, it is beneficial to target a promotional program to the specific needs and tastes of particular customers. It is therefore most beneficial to acquire and maintain accurate records of customer activity, such as, the type of product and/or service the specific customer typically purchases, the quantity, etc. One of the most difficult problems encountered in these targeted promotional programs is keeping track of all the customer activity. Another problem encountered is the ability to effectively ship the promotional items in a timely fashion, so as to obtain a beneficial response to the promotion.

Thus, there exists a need for a system and method which would address these and other problems encountered with previous type systems and methods so as to provide a method and system for an automated incentive-based program.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of instrumentalities and combinations particularly pointed out in the appended claims.

### SUMMARY OF THE INVENTION

In view of the aforementioned needs, the invention contemplates a method and system which automatically tracks and records customer activity, thus, enabling promotional items to be timely shipped to qualifying customers.

For a client beginning a promotion, the client supplies a database of their customers via email or a computer disk. The database is downloaded into a system in accordance with an embodiment of the present invention. A CD-ROM promotional brochure including a hyperlink is preferably generated. The customer database information is used to print a set of shipping labels. The CD-ROM promotional brochure is then mailed to the customers. The CD-ROM brochure is reviewed via computer by the customers, who are prompted to access a promotional web site through the hyperlink. Upon logging onto the promotional web site, customers can participate in the promotion, and may request free gifts or may order products to become eligible for premium gifts, via the web site. The customer may be prompted to respond to queries for soliciting customer information or feedback, as a contingency of participating in the promotion. The present system collects and stores the customer responses. This information is then prioritized and marked for processing. Based on this prioritized information, mailing labels are generated at predetermined intervals. Then, promotional items are pulled from an inventory and shipped to qualifying customers. The prioritized information received from customers is used to generate performance reports at regular intervals, detailing specific marketing data. A various stages of the promotion, overall promotion reports are generated and delivered to responsible parties for evaluation, to quantify the success and/or other performance factors of the promotional campaign.

With the present invention, customer information inputted in the web site is automatically collected and stored by the system. Thus, in the manner described above, the present invention allows for the automatic tracking of customer information during a promotion, thus providing an automated procedure for promoting products and services. This allows a product manufacturer or service provider to target customers most likely to purchase their product or service, thereby increasing the effectiveness of a promotional campaign.

Another advantage of the present invention is that it enables promotional items to be timely and accurately shipped to qualifying customers. Shipping information and labels are automatically generated from the recorded customer information, and promotional items are then shipped based on this information. This ensures accuracy and timeliness in shipping the promotional products, which in turn advances the success of the promotional program.

Among those benefits and improvements that have been disclosed, other objects and advantages of this invention will become apparent from the following description taken in conjunction with the accompanying drawings. The drawings constitute a part of this specification and include exemplary embodiments of the present invention and illustrate various objects and features thereof.

### BRIEF DESCRIPTION OF THE DRAWINGS

The drawings illustrate the best mode presently contemplated of carrying out the invention in which:

FIG. 1 is a block diagram view of an embodiment of the method for an incentive-based program of the present invention;

FIG. 2A is a block diagram view of an embodiment of the method of the present invention; and

FIG. 2B is a block diagram view of an embodiment of the method of the present invention.

### DETAILED DESCRIPTION OF EMBODIMENTS IN ACCORDANCE WITH THE INVENTION

The present invention includes a method and system for an incentive-based program designed to automatically track and record customer information, which is generated based on participation in promotional programs. The present method and system allows for the timely and accurate shipping of promotional items to qualifying customers, which in turn, advances the success of the promotional programs.

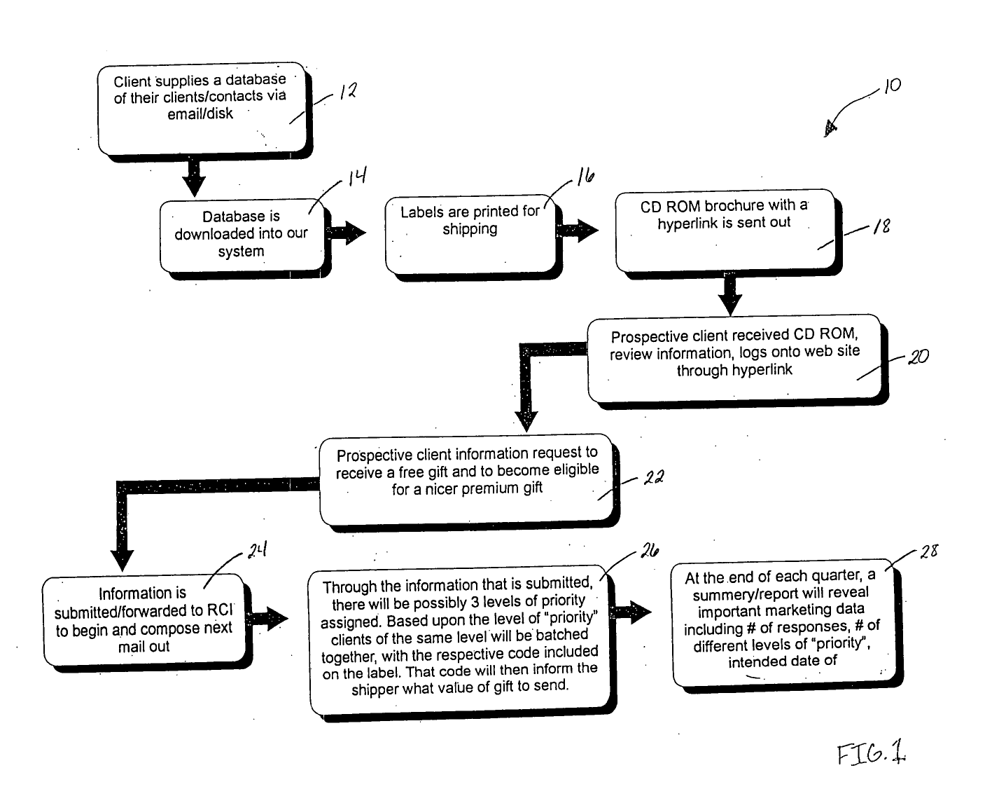

FIG. 1 generally indicates a method 10 in accordance with the present invention. As a preliminary, a promotional program is established between a client and a promotional agency. Thereafter, the client supplies a database 12 of customer information, preferably in machine readable format, and sent via email or a computer disk. The database can contain potential customers the client wishes to target and/or existing customers the client has already contacted. Once this database is compiled and delivered, the information is then downloaded 14 into the system of the promotional agency, so as to generate a mailing list. Based on this information, mailing labels are then printed 16 for shipping.

In the preferred embodiment, a CD-ROM brochure is generated. A CD-ROM promotion has a high viewing and response rate among recipients of direct mailings. The CD-ROM brochure is preferably a machine-implemented multimedia presentation providing a description of the promotion, and preferably targeted to the interests of a particular set of customers. The mailing lit database correlates each recipient with the unique serial number assigned to each CD-ROM. In this way, the CD-ROMs can be tracked and matched to particular recipients. The presentation includes one or more prompts to click an accompanying hyperlink, which references a proprietary web site that allows customers to participate in the on-going promotional program. The CD-ROM brochure with the hyperlink is sent out 18 to customers, preferably through the regular mail or some other suitable type of courier. Thus, customers who receive these CD-ROM via mail are able to view the CD-ROM presentation and log on 20 to the web site through the hyperlink. Upon accessing the web site, a customer is prompted 22 to complete a questionnaire which includes questions that provide desired market research information, such as the customer's name, address, phone number, email, needs and interests, spending habits, geographical location, income level, etc. The present system can update the potential customer's record based on this information, providing the client with an accurate database for future customer contacts, e.g. telephone and email follow-ups, etc. Afterwards, the customer is then able to request free promotional items and/or place orders for suitable products and/or services. Thus, customers need only load the CD-ROM onto their computer and click on the hyperlink, which will bring them right to the promotional web site. From there, customers can participate in the promotion by requesting free gifts or ordering products.

When the potential customer activates the CD-ROM, a message with the unique CD-ROM serial number is sent back to the system at the promotional agency. In this way, the promotional agency can determine which individual recipients have viewed the CD-ROM. Also, the CDs can be shipped using a courier that provides a tracking number, e.g. FedEx or another suitable courier. Upon receipt of the CD serial number message and/or the questionnaire response data, the interval can be estimated between shipping and receipt by the potential customer.

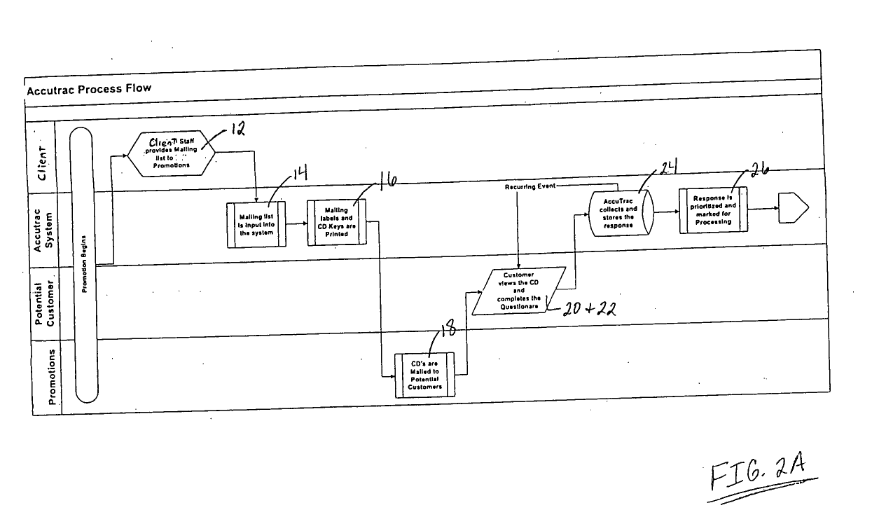

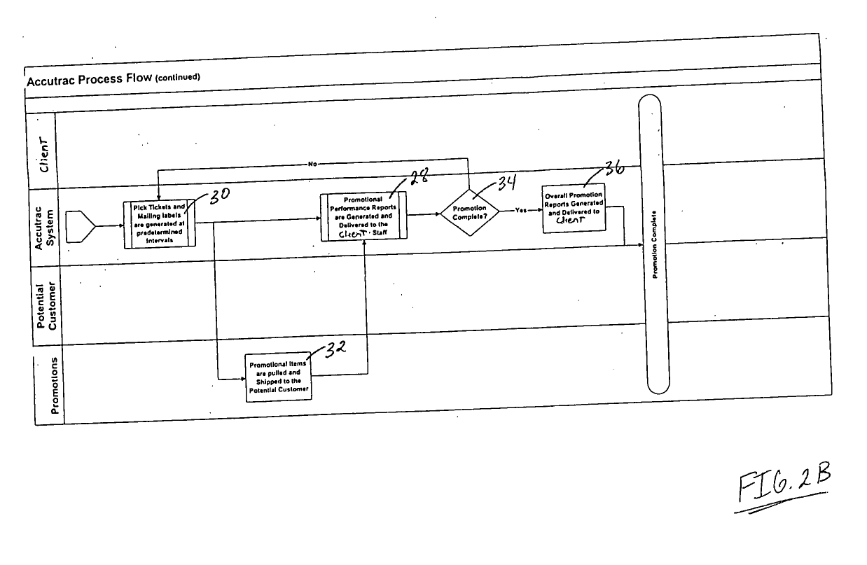

FIGS. 2A and 2B are flow charts which also indicate the process flow of the present method 10, including the steps indicated above, to show interaction and participation from the various parties involved in the promotion. When a promotion is started, the client supplies a database 12 of customer information, such as mailing list data. The information is then inputted 14 into the system of the promotional agency, indicated as the “Accutrac System.” The system preferably generates 16 mailing labels for shipping. The CD-ROM brochure with the hyperlink is preferably mailed 18 to customers by the promotional agency. The customers can then log on 20 to the web site through the hyperlink and be prompted 22 to complete the questionnaire.

The system of the promotional agency collects and stores 24 the customer responses to the questionnaire, requests for promotional items, and product orders. This system can be operated and maintained on a server hosting the proprietary web site, or it can be maintained on a separate computer system in communication with the proprietary web site, such as over a network, which can a LAN or a connection over the Internet, etc. The step of collecting and storing data 24 is a recurring event that recurs as customers log on and complete the questionnaire at different times. As customer response information is tracked and recorded from the web site, the response information is then prioritized 26, with respect to a number of different variables, such as type and quantity of products ordered, type and quantity of specific services requested, cash value of products and/or services that might be potentially ordered in the future, and a timeframe indicating how soon the products and/or services might be ordered, etc. The prioritized customer information is then used to generate 30 mailing labels, which can be performed at predetermined intervals. Customers having the same level of priority will receive a respective priority code. The labels can also designate the priority code for specific promotional items which are to be shipped in batches to the customers. For example, a potential customer who indicates that a large order of products and/or services might be purchased in the near future will receive higher priority over potential customers who might place a smaller order in the distant future. Once the labels are generated, the corresponding promotional items are pulled and shipped 32 by the promotional agency to the qualifying customers at designated intervals. For example, every 30 days, a new promotional item of increasing value may be sent to a potential customer. A pen may be sent one time, and a mug or other more expensive item may be sent at a later time. Potential customers of highest priority will receive the greatest number of items over the longest period, all with the client's name and log, so as to maximize the client's exposure among the potential customers.

At the end of a designated promotion period, e.g. each quarter, a report will be generated 28 compiling all of the customer information attained from the promotional program for that time period. The reports will be forwarded to the client for assessment of the progress of the promotion. Upon completion 34 of the promotional program, an overall report is also generated 36 detailing the totals of all of the customer information recorded throughout the entire promotional program. In this way, the steps of a promotion can be implemented so as to obtain market research information and other important customer feedback using a machine-implemented system that reduces labor and effort on the part of personnel at a promotional agency.

It should be appreciated that the present method can be implemented in other ways. For example, instead of mailing a CD-ROM presentation with a hyperlink, an email can be sent to a potential customer with a hyperlink to a proprietary web page that includes a presentation, with a questionnaire appended thereto. Also, a proprietary web page make accessed through links on related web pages, through “banner ads” or the like. Also, access to the proprietary web page can also be obtained through “pop up” windows or other tools such as known in the field of web marketing. Still further, questionnaires can be manually filled out on paper by potential customers at trade shows, market research offices, etc. From there, the questionnaire can be scanned or otherwise inputted into the system, so as to allow data collection and an automated promotional campaign in accordance with the present method. It may be contemplated that the present method may also be implemented through personal hand-held devices or other such electronic interfaces which may become popular in coming years. All of the above can be envisioned as implemented so as to obtain online customer market research data in exchange for targeted promotional items, all without departing from the invention.

Although the invention has been shown and described with respect to a certain preferred embodiment, it is obvious that equivalent alterations and modifications will occur to others skilled in the art upon the reading and understanding of this specification. The present invention includes all such equivalent alterations and modifications.

What is claimed:

1. A method of promotion comprising:
contacting at least one potential customer;
prompting the potential customer to access and complete a questionnaire to provide customer input information;
collecting and storing customer input information;
providing the potential customer with at least one promotional item in response to completing the questionnaire.

2. The method of claim 1 in which the step of contacting at least one potential customer is preceded by a step of obtaining a database of customer information from a client, wherein the customer information includes customer contact information.

3. The method of claim 2 wherein the database is provided in a machine readable format, and is sent from the client via email or a computer disk.

4. The method of claim 3 wherein the database is inputted into a system to generate a customer mailing list.

5. The method of claim 4 wherein the step of generating a customer mailing list comprises printing customer mailing labels.

6. The method of claim 1 wherein the step of contacting at least one potential customer comprises mailing to the customer a CD-ROM brochure including a web hyperlink, and wherein the step of prompting the potential customer to access and complete a questionnaire is web-implemented through the CD-ROM brochure.

7. The method of claim 6 further comprising a step of returning a message with the CD-ROM's unique serial number when the potential customer activates the CD-ROM, so as to determine which potential customer has viewed the CD-ROM.

8. The method of claim 6 further comprising a step of correlating a potential customer's response with a courier tracking number so as to estimate an interval between shipping the CD-ROM and receipt by the potential customer.

9. The method of claim 1 wherein the step of contacting at least one potential customer comprises providing a web-based prompt including a web hyperlink, and wherein the step of prompting the potential customer to access and complete a questionnaire is implemented over a proprietary web page accessed by the hyperlink.

10. The method of claim 9 wherein the web-based prompt including the web hyperlink comprises at least one of a link on a web page and a proprietary “pop up” window web page.

11. The method of claim 1 wherein the step of prompting the potential customer to access and complete a questionnaire to provide customer input information comprises prompting the potential customer to provide market research information on at least one of: the customer's needs and interests, spending habits, geographical location and income level.

12. The method of claim 1 wherein the step of providing the potential customer with at least one promotional item in response to completing the questionnaire comprises at least one of: enabling the customer to request free promotional items; and place orders for at least one of suitable products and services.

13. The method of claim 1 wherein the step of collecting and storing customer input information is operated and maintained on at least one of: a server hosting the questionnaire; and a separate computer system in communication with the questionnaire over a network including at least one of a LAN and a connection over the Internet.

14. The method of claim 1 wherein the step of collecting and storing customer input information is performed a recurring number of times as a plurality of customers log on and complete the web-based questionnaire at different times.

15. The method of claim 1 wherein the step of providing the potential customer with at least one promotional item comprises prioritizing customer input information with respect to at least one of: type and quantity of products ordered; and type and quantity of specific services requested.

16. The method of claim 15 wherein the step of providing the potential customer with at least one promotional item comprises using the customer input information to generate mailing labels, which can also designate the specific promotional items to be shipped.

17. The method of claim 1 further comprising a step of generating a report compiling customer input information and forwarding the report to the client detailing activity of customer input information recorded throughout a promotional program.

18. A computer-implemented automated promotional tool comprising:
an implementation for contacting at least one potential customer;
an implementation for prompting the potential customer to access and complete a questionnaire to provide customer input information;
an implementation for collecting and storing customer input information;
an implementation for providing the potential customer with at least one promotional item in response to completing the questionnaire.

19. The promotional tool of claim 18 in which the implementation for contacting at least one potential customer is preceded by an implementation for obtaining a database of customer information from a client, wherein the customer information includes customer contact information.

20. The promotional tool of claim 19 wherein the database is provided in a machine readable format, and is sent from the client via email or a computer disk.

21. The promotional tool of claim 20 wherein the database is inputted into a system to generate a customer mailing list.

22. The promotional tool of claim 21 wherein the implementation for generating a customer mailing list comprises an implementation for printing customer mailing labels.

23. The promotional tool of claim 18 wherein the implementation for contacting at least one potential customer comprises an implementation for mailing to the customer a CD-ROM brochure including a web hyperlink, and wherein the implementation for prompting the potential customer to access and complete a questionnaire is web-implemented through the CD-ROM brochure.

24. The promotional tool of claim 23 further comprising an implementation for returning a message with the CD-ROM's unique serial number when the potential customer activates the CD-ROM, so as to determine which potential customer has viewed the CD-ROM.

25. The promotional tool of claim 23 further comprising an implementation for correlating a potential customer's response with a courier tracking number so as to estimate an interval between shipping the CD-ROM and receipt by the potential customer.

26. The promotional tool of claim 18 wherein the implementation for contacting at least one potential customer comprises an implementation for providing a web-based prompt including a web hyperlink, and wherein the implementation for prompting the potential customer to access and complete a questionnaire is implemented over a proprietary web page accessed by the hyperlink.

27. The promotional tool of claim 26 wherein the web-based prompt including the web hyperlink comprises at least one of a link on a web page and a proprietary “pop up” window web page.

28. The promotional tool of claim 18 wherein the implementation for prompting the potential customer to access and complete a questionnaire to provide customer input information comprises an implementation for prompting the potential customer to provide market research information on at least one of: the customer's needs and interests, spending habits, geographical location and income level.

29. The promotional tool of claim 18 wherein the implementation for providing the potential customer with at least one promotional item in response to completing the questionnaire comprises at least one of: an implementation for enabling the customer to request free promotional items; and implementation for placing orders for at least one of suitable products and services.

30. The promotional tool of claim 18 wherein the implementation for collecting and storing customer input information is operated and maintained on at least one of: a server hosting the questionnaire; and a separate computer system in communication with the questionnaire over a network including at least one of a LAN and a connection over the Internet.

31. The promotional tool of claim 18 wherein the implementation for collecting and storing customer input information is performed a recurring number of times as a plurality of customers log on and complete the questionnaire at different times.

32. The promotional tool of claim 18 wherein the implementation for providing the potential customer with at least one promotional item comprises an implementation for prioritizing customer input information with respect to at least one of: type and quantity of products ordered; and type and quantity of specific services requested.

33. The promotional tool of claim 28 wherein the implementation for providing the potential customer with at least one promotional item comprises an implementation for using the customer input information to generate mailing labels, which can also designate the specific promotional items to be shipped.

34. The promotional tool of claim 18 further comprising an implementation for generating a report compiling customer input information and further comprising an implementation for forwarding a report to the client detailing activity of customer input information recorded throughout a promotional program.
